(19) United States
(12) Patent Application Publication
(10) Pub. No.: US 2008/0125095 A1
(43) Pub. Date: May 29, 2008

(54) METHOD OF RECOGNIZING AN EVENT TRANSPIRING AT A TERMINAL DEVICE

(75) Inventors: DAVID MORNHINEWAY, SAN ANTONIO, TX (US); EDWARD WALTER, BOERNE, TX (US); ANUP D. KARNALKAR, ALLEN, TX (US); LARRY B. PEARSON, SAN ANTONIO, TX (US)

Correspondence Address: AKERMAN SENTERFITT, P.O. BOX 3188, WEST PALM BEACH, FL, 33402-3188, US

(73) Assignee: SBC KNOWLEDGE VENTURES, L.P., RENO, NV (US)

(21) Appl. No.: 11/533,698

(22) Filed: Sep. 20, 2006

(51) Int. Cl. H04M 1/00; H04M 3/42

(52) U.S. Cl. 455/412.2; 455/415; 455/413; 379/88.12; 370/259

(57) ABSTRACT

A method of recognizing an event transpiring at a terminal device is disclosed. An apparatus that incorporates teachings of the present disclosure may include, for example, a terminal device having a User Interface (UI) element that radiates at least one among a light emission pattern and a tactile emission pattern for recognizing one among a caller ID during an incoming call initiated by a calling party and a voicemail associated with the calling party when the incoming call is unanswered. Additional embodiments are disclosed.

### FIELD OF THE DISCLOSURE

The present disclosure relates generally to notification techniques and more specifically to a method of recognizing an event transpiring at a terminal device.

### BACKGROUND

Terminal devices such as cell phones and Personal Digital Assistants (PDAs) have become common staple communication devices for many people. Such devices have evolved over the years in complexity to perform a number of functions such as receiving calls, emails, pages, Short Message System (SMS) messages, generating calendar reminders, instant messages, and so on. When events such as these occur, the end user is notified by a User Interface (UI) such as an audible alert (e.g., ring tones) which directs the end user to view a display associated with the UI to identify the actual event (e.g., caller ID of incoming call, pending SMS message, etc.). Although ring tones have been customized by caller ID to identify a calling party, such a method is not desirable when the end user prefers privacy or a quiet environment. Moreover such a method is not helpful to the hearing impaired.

A need therefore arises for a method of recognizing an event transpiring at a terminal device.

### BRIEF DESCRIPTION OF THE DRAWINGS

FIG. 1 depicts an exemplary embodiment of a terminal device;

FIG. 2 depicts an exemplary method operating in the terminal device;

FIGS. 3-4 depict exemplary embodiments of a housing assembly for the terminal device; and

FIG. 5 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a method of recognizing an event transpiring at a terminal device.

In a first embodiment of the present disclosure, a terminal device can have a User Interface (UI) element that radiates at least one among a light emission pattern and a tactile emission pattern for recognizing one among a caller ID during an incoming call initiated by a calling party and a voicemail associated with the calling party when the incoming call is unanswered.

In a second embodiment of the present disclosure, a computer-readable storage medium in a terminal device can have computer instructions for directing a User Interface (UI) element to radiate at least one among a light emission pattern and a tactile emission pattern for recognizing at least one among a first caller ID during an incoming call initiated by a first calling party, a voicemail associated with the first calling party when the incoming call is unanswered, a second caller ID associated with an unanswered call initiated by a second calling party, an email, a Short Messaging System (SMS) message, a page, and an instant message (IM message).

In a third embodiment of the present disclosure, a method in a terminal device can have the step of radiating at least one among a light emission pattern and a tactile emission pattern for recognizing a caller ID associated with a messaging event.

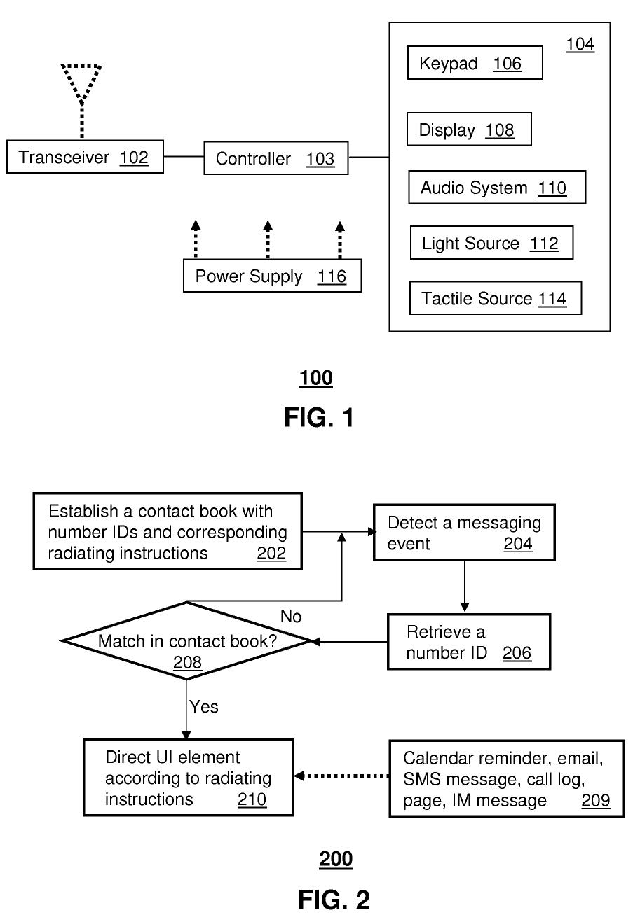

FIG. 1 depicts an exemplary embodiment of a terminal device 100. The terminal device 100 can comprise a wireless or wireline transceiver 102, a user interface (UI) 104, a power supply 116, and a controller 103 for managing operations of the foregoing components. The transceiver 102 can utilize common communication technologies to support singly or in combination any number of wireline access technologies such as cable, xDSL, Public Switched Telephone Network (PSTN), and so on. Singly or in combination with the wireline technology, the transceiver 102 can support singly or in combination any number of wireless access technologies including without limitation Bluetooth™, Wireless Fidelity (WiFi), Worldwide Interoperability for Microwave Access (WiMAX), Ultra Wide Band (UWB), software defined radio (SDR), and cellular access technologies such as CDMA-1X, W-CDMA/HSDPA, GSM/GPRS, TDMA/EDGE, and EVDO. SDR can be utilized for accessing public and private communication spectrum with any number of communication protocols that can be dynamically downloaded over-the-air to the terminal device 100. It should be noted also that next generation wireline and wireless access technologies can also be applied to the present disclosure.

The UI element 104 can include a keypad 106 with depressible or touch sensitive keys and a navigation element such as a navigation disk, button, roller ball, or flywheel for manipulating operations of the terminal device 100. The keypad 106 and its components can be illuminated by light sources such as light emitting diodes (LEDs) that can be adjusted to generate controlled light emissions of various colors. The UI element 104 can further include a display 108 such as monochrome or color LCD (Liquid Crystal Display) which can be touch sensitive for manipulating operations and for conveying images to the end user of the terminal device 100, and an audio system 110 that utilizes common audio technology for conveying and intercepting audible signals of the end user.

The UI element 104 also includes a light source 112 comprising, for example, light emitting diodes (LEDs) that can be adjusted to generate controlled light emissions of various colors. Each of the one or more lighting components of the light source 112 can be placed at various locations of the terminal device 100 such as, for example, the keys and/or navigation components of the keypad 106, an antenna stub of the terminal device 100, and so on. The UI element 104 further includes a tactile source 114 for generating signals that can be detected by a human being's sense of touch. For example, the tactile source 112 can be represented by a common electro-mechanical vibration system for applying controlled vibrations to a housing assembly of the terminal device 100. The tactile source 114 can alternatively comprise a heating element that emanates heat from a portion of the housing assembly of the terminal device 100.

The components of the UI element 104 described above can singly or in combination be used to convey information to an end user of the terminal device 100.

The power supply 116 can utilize common power management technologies such as replaceable batteries, supply regulation technologies, and charging system technologies for supplying energy to the components of the terminal device 100 and to facilitate portable applications. Depending on the type of power supply 116 used, the terminal device 100 can represent an immobile or portable communication device. The controller 103 can utilize computing technologies such as a microprocessor and/or digital signal processor (DSP) with associated storage memory such a Flash, ROM, RAM, SRAM, DRAM or other like technologies for controlling operations of the terminal device 100.

FIG. 2 depicts an exemplary embodiment of a method 200 operating in the terminal device 100. Method 200 begins with step 202 in which the terminal device 100 is programmed to establish a contact book with number IDs and corresponding radiating instructions for directing the lighting and tactile sources 112, 114 of the UI element 104. Each entry in the contact book can consist of an individual's name, a home, business, and/or mobile number to reach said individual, an email address, and radiating instructions when any of the foregoing contact information matches identification information associated with a messaging event. The radiating instructions can consist of light and/or tactile emission patterns for recognizing a messaging event associated with the individual of said entry. Any light or tactile emission patterns suitable to the present disclosure can be defined.

The contact book can be established by an end user of the terminal device 100 manually by entering each contact book entry by way of the keypad 106. Alternatively, the end user can create the contact book on a computer or on-line, and download the resulting contact book by tethered wireline through, for example, a USB port, or wirelessly using a short range wireless system (e.g., Bluetooth or WiFi) or by way of a long-range communication system such as cellular network.

Once the contact book has been stored in a memory element of the terminal device 100, the terminal device 100 can proceed to step 204 where it is ready to detect messaging events. A messaging event can correspond to any messaging technique for relaying messages to a user of the terminal device 100. For example, a messaging event can comprise an incoming voice call initiated by a calling party, a voicemail associated with the calling party when the incoming call is unanswered, a missed call from a party who has not provided an accompanying voicemail, arrival of an email message, a Short Messaging System (SMS) message, a page, and/or an IM message. Other messaging events suitable to the present disclosure can be used.

Upon detecting a messaging event, the terminal device 100 proceeds to step 206 to retrieve a number ID associated with the messaging event. The number ID can be any information that identifies the source of the messaging event. For example, during an incoming call, the number ID can represent the caller ID of the calling party. The caller ID can be extracted as an Automatic Number Identification (ANI) associated with a PSTN call. The caller ID can alternatively consist of a number ID retrieved from Session Initiation Protocol (SIP) or H.323 signaling information associated with a VoIP or IP video call. A similar caller ID can be retrieved for voicemail, missed call logs, SMS messages, and pages. In the case of an email or IM message, the caller ID is associated with the email or IM address of the sender.

Once the number ID has been retrieved from the messaging event, the terminal device 100 checks in step 208 for one or more matched entries in the contact book. If no matched entries are found, the terminal device proceeds to step 204 to check for more messaging events. If a match is found, the terminal device 100 proceeds to step 210 to direct the UI element 104 to radiate the light and/or tactile sources as instructed by the matched entry.

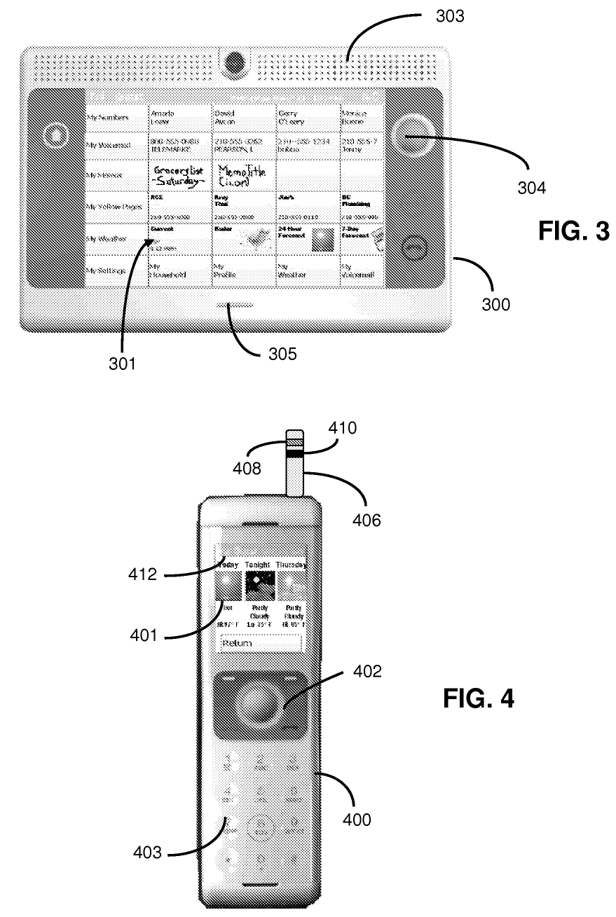

FIGS. 3-4 depict exemplary embodiments of a housing assembly for the terminal device 100. In FIG. 3, the terminal device 100 resembles a frame 200 having a touch screen display 301, navigation roller ball 304, and audio system having speakers 303 and a microphone 305. FIG. 4 depicts the terminal device 100 as a handset 400. The handset has a display 401, and keypad having depressible keys 403 and a navigation roller ball 402. Although not shown, each of the frame 300 and handset 400 can include a tactile source 114 such as a vibration system.

The frame 300 and handset 400 can be an integral part of each other much like cordless phones and base units today. Alternatively, the handset 400 can represent a dual mode phone supporting cellular and cordless technology. In yet another embodiment, the frame 300 and handset 400 can operate as unrelated communication devices. The display and navigation elements of the frame 300 and handset 400 can be illuminated by components of the light source 112. Similarly, components of the light source 112 can be applied to other portions of the handset 400 such as the antenna stub 406. In the present illustration, the antenna stub 406 includes first and second lighting components 408-410.

Referring back to step 210, the terminal device 100 can direct a portion of the UI element 104, i.e., the light and/or tactile sources 112, 114 to radiate to an emission pattern defined in the matched entry. For example, the light source 112 can be applied to the roller ball 304 of frame 300 so that it can be illuminated in different colors. The end user of the frame 300 can in turn program the contact book entries to illuminate according to a pattern that identifies an individual for each entry. For instance, the contact book entry of “Joe Doe” can be programmed to illuminate as a flashing blue roller ball 304. The entry for “Sam Doe” can be programmed to illuminate as a static yellow roller ball 304.

In another embodiment, the light source 112 can be applied to the roller ball 304 in such a manner as to produce the illumination of concentric circles with one or more colors. Thus when a caller ID match is detected from an incoming call from “Joe Doe”, concentric colored patterns can be illuminated according to instructions set forth in the contact book.

To distinguish between incoming calls, missed calls stored in call logs, voicemail, SMS messages, pages, IM messages, and so on, different patterns can be applied by the end user. For example, flashing lights indicate an incoming call. The color of the flashing lights can be used to recognize the caller ID of the calling party. Concentric lights can be used for voicemail with colors used to identify a caller ID. Sequential patterns such as trailing lights can be used to identify call logs. Similarly, other patterns and colors can be identified for recognizing SMS messages, emails and pages and their respective caller IDs. Additionally, the emission patterns and color associations can be applied to other light components such as antenna stub 406 of the handset 400.

In an alternative embodiment, calendar reminders, email, SMS messages, call logs, pages, and IM messages can be identified by the terminal device in step 209 as a category without identifying a caller ID. That is, an emission pattern can be selected in step 210 to identify a calendar reminder event (fast light strobe), email event (fast concentric light emissions), SMS message event (fast sequence light emissions), call log event (combined fast flash and concentric light emissions), and/or page event (combined fast sequence and concentric light emissions), respectively.

The tactile source 114 can also be directed to generate emission patterns to identify categories of messaging events as well as caller IDs. For example, a repeatable long single pulse vibration followed by three fast pulse vibrations can assist an end user to recognize an incoming call (long single pulse) from “Joe Doe” (fast three pulse). The pulsed vibration patterns can be detected by the end user while carrying the handset 400 or from vibrations propagated through a surface which the frame 300 has been placed on.

In a supplemental embodiment, the scope of emission patterns supported by frame 300 and/or handset 400 can be augmented by combining tactile emissions with light emissions.

Any light and/or tactile emission patterns can be selected by the end user to recognize messaging events in the form of categories singly or in association with a caller ID. The aforementioned embodiments afford the end user a means to privately recognize messaging events without interrupting others with loud audible alerts. Said embodiments can also assist the hearing impaired.

Upon reviewing the aforementioned embodiments, it would be evident to an artisan with ordinary skill in the art that said embodiments can be modified, reduced, or enhanced without departing from the scope and spirit of the claims described below. For example, the placement of the light source 112 can vary from what is depicted in FIGS. 3-4. Similarly, other emission patterns can be used that are not described by the present disclosure. These are but a few examples of modifications that can be applied to the present disclosure without departing from the scope of the claims stated below. Accordingly, the reader is directed to the claims section for a fuller understanding of the breadth and scope of the present disclosure.

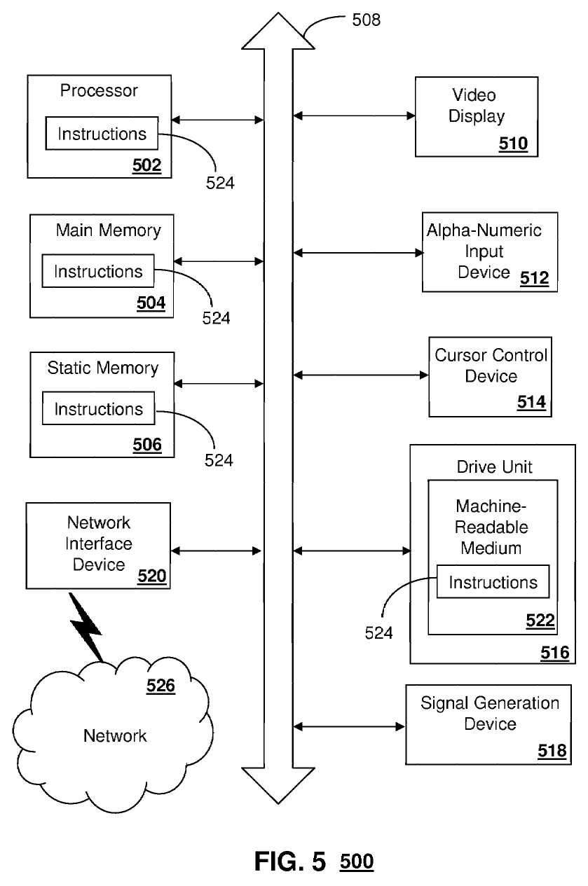

FIG. 5 depicts an exemplary diagrammatic representation of a machine in the form of a computer system 500 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 500 may include a processor 502 (e.g., a central processing unit (CPU), a graphics processing unit (GPU, or both), a main memory 504 and a static memory 506, which communicate with each other via a bus 508. The computer system 500 may further include a video display unit 510 (e.g., a liquid crystal display (LCD), a flat panel, a solid state display, or a cathode ray tube (CRT)). The computer system 500 may include an input device 512 (e.g., a keyboard), a cursor control device 514 (e.g., a mouse), a disk drive unit 516, a signal generation device 518 (e.g., a speaker or remote control) and a network interface device 520.

The disk drive unit 516 may include a machine-readable medium 522 on which is stored one or more sets of instructions (e.g., software 524) embodying any one or more of the methodologies or functions described herein, including those methods illustrated above. The instructions 524 may also reside, completely or at least partially, within the main memory 504, the static memory 506, and/or within the processor 502 during execution thereof by the computer system 500. The main memory 504 and the processor 502 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 524, or that which receives and executes instructions 524 from a propagated signal so that a device connected to a network environment 526 can send or receive voice, video or data, and to communicate over the network 526 using the instructions 524. The instructions 524 may further be transmitted or received over a network 526 via the network interface device 520.

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A terminal device, comprising a User Interface (UI) element that radiates at least one among a light emission pattern and a tactile emission pattern for recognizing one among a caller ID during an incoming call initiated by a calling party, and a voicemail with a calling ID indication associated with the calling party when the incoming call is unanswered.

2. The terminal device of claim 1, comprising a receiving element that retrieves a number ID from the incoming call, wherein the UI element radiates at least one among the light and tactile emission patterns upon detecting a match between the number ID and an entry in a contact book.

3. The terminal device of claim 2, wherein the contact book comprises a plurality of number IDs and a corresponding plurality of instructions for radiating at least one among the light and tactile emission patterns in response to a match detected by the UI element between the number ID retrieved by the receiving element and a number ID in the contact book.

4. The terminal device of claim 3, wherein the UI element comprises one or more light sources, and wherein the UI element directs at least one of the one or more light sources according to a pattern defined by the matched entry in the contact book.

5. The terminal device of claim 4, wherein at least one of the one or more light sources is located in a portion of a housing assembly of the terminal device comprising one among an antenna stub, a keypad, and a navigation element of the UI element, wherein the navigation element comprises at least one among a navigation disk, a button, a roller ball, and a flywheel.

6. The terminal device of claim 3, wherein the UI element comprises a tactile source for radiating a mechanical movement of a housing assembly of the terminal device, and wherein the UI element directs the tactile source according to a pattern defined by the matched entry in the contact book.

7. The terminal device of claim 1, wherein the terminal device comprises at least one among a wireless communication device, and a wireline communication device.

8. The terminal device of claim 1, wherein the terminal device comprises a communication device operating according to at least one among a circuit-switched standard and a packet-switched standard, wherein the communication device comprises one among a portable communication device, and a substantially immobile communication device, wherein the circuit-switched standard comprises at least one among a cellular telephony standard, and a Public Switched Telephone Network (PSTN) standard, and wherein the packet-switched standard comprises at least one among a Voice over IP (VOIP) standard, and a video IP telephony standard.

9. The terminal device of claim 1, comprising:
a receiving element that receives at least one among an email, a Short Messaging System (SMS) message, and a page; and
a calendar element that generates calendar reminders,
wherein the UI element radiates at least one among a light emission pattern and a tactile emission pattern for identifying one among a calendar reminder, a pending unread email, a pending unread SMS message, a pending unread page, a second caller ID associated with an unanswered call initiated by another calling party, and arrival of an instant message (IM).

10. A computer-readable storage medium in a terminal device, comprising computer instructions for directing a User Interface (UI) element to radiate at least one among a light emission pattern and a tactile emission pattern for recognizing at least one among a first caller ID during an incoming call initiated by a first calling party, a voicemail with a calling ID indication associated with the first calling party when the incoming call is unanswered, a second caller ID associated with an unanswered call initiated by a second calling party, an email, a Short Messaging System (SMS) message, a page, and an instant message (IM message).

11. The storage medium of claim 10, comprising computer instructions for:
retrieving from the incoming call a number ID corresponding to the caller ID of the calling party; and
directing the UI element to radiate at least one among the light and tactile emission patterns upon detecting a match between the number ID and an entry in a contact book.

12. The storage medium of claim 11, comprising computer instructions for:
receiving entries for the contact book comprising a plurality of number IDs and a corresponding plurality of instructions for radiating at least one among the light and tactile emission patterns; and
directing the UI element to radiate at least one among the light and tactile emission patterns according to the radiating instructions associated with the matched entry in the contact book.

13. The storage medium of claim 12, wherein the UI element comprises one or more light sources, and wherein the storage medium comprises computer instructions for directing at least one of the one or more light sources according to the light radiating instructions associated with the matched entry in the contact book.

14. The storage medium of claim 12, wherein the UI element comprises a tactile source for radiating a mechanical movement of a housing assembly of the terminal device, and wherein the storage medium comprises computer instructions for directing the tactile source according to the tactile radiating instructions associated with the matched entry in the contact book.

15. The storage medium of claim 10, comprising computer instructions for:
detecting one among a plurality of matches between entries in a contact book and the first caller ID associated with one among the incoming call and the voicemail, second caller ID, a third caller ID associated with the email, a fourth caller ID associated with the SMS message, a fifth caller ID associated with the page, and sixth caller ID associated with an IM message;
directing the UI element to radiate at least one among a light emission pattern and a tactile emission pattern according to radiating instructions in the matched entry of the contact book.

16. The storage medium of claim 10, comprising computer instructions for processing the incoming call from the first caller according to at least one among a circuit-switched standard and a packet-switched standard.

17. A method in a terminal device, comprising radiating at least one among a light emission pattern and a tactile emission pattern for recognizing a caller ID associated with a messaging event.

18. The method of claim 17, comprising:
retrieving a number ID corresponding to a calling party associated with the messaging event; and
radiating at least one among the light and tactile emission patterns upon detecting a match between the number ID and an entry in a contact book.

19. The method of claim 18, comprising radiating at least one among the light and tactile emission patterns according to radiating instructions associated with the matched entry in the contact book.

20. The method of claim 18, comprising enabling at least one among one or more light sources and a tactile source according to light and tactile radiating instructions associated with the matched entry in the contact book.
